(19) United States
(12) Patent Application Publication
(10) Pub. No.: US 2024/0403941 A1
(43) Pub. Date: Dec. 5, 2024

(54) INFORMATION PROCESSING METHOD, INFORMATION PROCESSING DEVICE, AND NON-TRANSITORY COMPUTER READABLE RECORDING MEDIUM

(71) Applicant: Panasonic Intellectual Property Corporation of America, Torrance, CA (US)

(72) Inventors: Tatsumi Nagashima, Osaka (JP); Motoji Ohmori, Osaka (JP); Minami Naka, Tokyo (JP)

(21) Appl. No.: 18/805,843

(22) Filed: Aug. 15, 2024

Related U.S. Application Data
(63) Continuation of application No. PCT/JP2022/040529, filed on Oct. 28, 2022.

(30) Foreign Application Priority Data
Feb. 22, 2022 (JP) 2022-025918

(51) Int. Cl. G06Q 30/0601; G06Q 10/02; G06Q 10/0875

(52) U.S. Cl. CPC G06Q 30/0635; G06Q 10/02; G06Q 10/0875

(57) ABSTRACT

A computer executes; acquiring entry information indicating an entry of a user into an administrative region of a store and including a user ID, and ordered commodity information indicating an ordered commodity associated with the user ID; determining location information about a parking location for the user to park a vehicle as parking location information on the basis of parking information including location information about parking locations in a parking place in the administrative region of the store and the ordered commodity information, the parking information and the commodity information being held in a memory; and outputting output information including the parking location information.

### FIELD OF INVENTION

The present disclosure relates to a technology of providing information about delivery of commodities at a store.

### BACKGROUND ART

Patent Literature 1 discloses a technology of allowing a user to receive, at a parking lot or place of a store, a commodity of the store ordered online in advance. Specifically, Patent Literature 1 discloses a technology of, upon detection of an arrival of a vehicle of a user at a parking place of a store, arranging a commodity ordered by the user in a kiosk, displaying an instruction of delivering the commodity from the kiosk to the vehicle on a display of the kiosk, and making a clerk deliver the commodity from the kiosk to the vehicle in accordance with the instruction.

However, the technology of Patent Literature 1 fails to consider a burden on the clerk, and a deterioration of and a damage to a commodity in a delivery of the commodity to a parking location, and thus needs further improvement for an efficient delivery of the commodity in the parking place.
Patent Literature 1: US Patent Publication No. 10373226

### SUMMARY OF THE INVENTION

The present disclosure has been accomplished to solve the drawbacks described above, and has an object of providing a technology of achieving an efficient delivery of a commodity in a parking place.

An information processing method according to one aspect of the present disclosure is an information processing method for providing information about delivery of commodities at a store. The information processing method includes: by a computer, acquiring entry information indicating an entry of a user into an administrative region of the store and including a user ID, and ordered commodity information indicating an ordered commodity associated with the user ID; determining location information about a parking location for the user to park a vehicle as parking location information on the basis of parking information including location information about parking locations in a parking place in the administrative region and the ordered commodity information, the parking information and the commodity information being held in a memory; and outputting output information including the parking location information.

This disclosure achieves an efficient delivery of a commodity in a parking place.

### BRIEF DESCRIPTION OF THE DRAWINGS

FIG. 1 is a block diagram showing an example of an overall configuration of an information processing system in a first embodiment of the present disclosure.

FIG. 2 is a table showing an example of a data configuration of an ordered commodity database.

FIG. 3 is an illustration of a first example of parking information.

FIG. 4 is an illustration of a second example of the parking information.

FIG. 5 is a table showing an example of a data configuration of a commodity information list.

FIG. 6 is a flowchart showing a first example of a process by the information processing system in the first embodiment.

FIG. 7 is an illustration of a display screen image in a first example displaying output information on a display of each of a user terminal and a store terminal.

FIG. 8 is an illustration of a display screen image in a second example displaying output information on the display of each of the user terminal and the store terminal.

FIG. 9 is a flowchart showing a second example of the process by the information processing system in the first embodiment.

FIG. 10 is a flowchart showing a first example of step S6 in FIG. 6 and FIG. 9.

FIG. 11 is a flowchart showing a second example of step S6 in FIG. 6 and FIG. 9.

FIG. 12 is an illustration of parking information in a second embodiment of the disclosure.

FIG. 13 is an illustration of details of the parking information in the second embodiment of the disclosure.

FIG. 14 is an illustration of parking information in a third embodiment of the disclosure.

FIG. 15 is an illustration of an example of parking information in a fourth embodiment of the disclosure.

FIG. 16 is a flowchart showing an example of a process by an information processing system in a sixth embodiment of the disclosure.

### DETAILED DESCRIPTION

### Knowledge Forming the Basis of the Present Disclosure

A service for delivering a commodity of a store ordered online in advance to a user in a parking place of the store has been studied. In this service, when the user parks a vehicle thereof in the parking place of the store, a clerk delivers the commodity from the store to a parking location. This allows the user to receive the commodity without entering the store.

However, in a delivery of a large commodity, such as a piece of furniture, a long distance from the store to a parking location may increase a burden on the clerk. Further, in a delivery of each of a large commodity and a precision machine, a long distance from the store to a parking location may cause a risk of damaging the commodity. Moreover, in a delivery of each of a frozen food and a fresh food, a long distance from the store to a parking location may cause a risk of deteriorating the commodity. It is seen from these perspectives that a further improvement is necessary to achieve an efficient delivery of a commodity in a parking place.

Under the circumstances, the present inventors have obtained the knowledge that an efficient delivery of a commodity is achievable by determining a parking location to park for a user having come to receive an ordered commodity and making the user park a vehicle thereof at the parking location, and the inventors have conceived of the features to be described below.

(1) An information processing method according to one aspect of the present disclosure is an information processing method for providing information about delivery of commodities at a store. The information processing method includes: by a computer, acquiring entry information indicating an entry of a user into an administrative region of the store and including a user ID, and ordered commodity information indicating an ordered commodity associated with the user ID; determining location information about a parking location for the user to park a vehicle as parking location information on the basis of parking information including location information about parking locations in a parking place in the administrative region and the ordered commodity information, the parking information and the commodity information being held in a memory; and outputting output information including the parking location information.

In this configuration, when a user having come to receive an ordered commodity enters an administrative region of a store, location information about a parking location for the user to park is determined as parking location information on the basis of parking information indicating parking locations in a parking place and ordered commodity information, and the parking location information is output. This achieves an efficient delivery of a commodity in the parking place.

(2) In the information processing method in (1) above, the parking place may include a first area which is within a first predetermined distance from the store. In the determining, it may be determined on the basis of a commodity information list held in the memory and showing commodities in the store whether the ordered commodity includes a specific commodity, and location information about the first area may be determined as the parking location information when the ordered commodity is determined to include the specific commodity.

In this configuration, when the ordered commodity includes a specific commodity, the location information about the first area which is within the first predetermined distance from the store is determined as the parking location information, and thus, this configuration enables suppression of a burden in the delivery of the specific commodity and a deterioration of and a damage to the specific commodity in the delivery.

(3) In the information processing method according to (1) or (2) above, the first area may be a parking area which is within the first predetermined distance from a doorway of the store.

This configuration enables determination of a parking area in an actually shorter delivery route for the ordered commodity as a parking location in consideration of a doorway of the store.

(4) In the information processing method according to any one of (1) to (3) above, in the acquiring, vacant information indicating a vacant space which is vacant without being occupied by a vehicle in the parking place may be acquired. In the determining, when the specific commodity is determined to be included, it may be determined on the basis of the vacant information and the location information about the first area whether the first area includes the vacant space, and the location information about the first area may be determined as the parking location information when the first area is determined to include the vacant space.

This configuration enables determination of the first area which is available for parking.

(5) In the information processing method according to any one of (1) to (4) above, the parking location information may include location information about the vacant space in the first area.

This configuration enables determination of a parking location which is available for parking in the first area in more details.

(6) In the information processing method according to any one of (1) to (5) above, the store may have a plurality of doorways. In the acquiring, commodity location information indicating respective locations of the commodities in the store and doorway information indicating respective locations of the doorways may be acquired. In the determining, a location of the ordered commodity may be specified on the basis of the commodity location information and the ordered commodity information, and a first doorway which is at a shortest distance from the specified location of the ordered commodity among the doorways is specified on the basis of the doorway information. The first area may be a parking area which is within the first predetermined distance from the first doorway.

In this configuration, in a case where the store has a plurality of doorways, location information about a parking area which is within the first predetermined distance from a doorway near the location of the ordered commodity is determined as the parking location information. This configuration thus enables determination of a parking area in a shorter delivery route for the ordered commodity as a parking location, and thus attains an efficient delivery of the ordered commodity.

(7) In the information processing method according to any one of (1) to (6) above, the store may have a plurality of doorways. The ordered commodity information may indicate a plurality of the ordered commodities. In the acquiring, location information about a store terminal, commodity location information indicating respective locations of the commodities in the store, and doorway information indicating respective locations of the doorways may be further acquired. In the determining, a location of a first ordered commodity which is outside a second predetermined distance from a location of the store terminal among the ordered commodities may be specified on the basis of the ordered commodity information, the commodity location information, and the location information about the store terminal, and a first doorway which is at a shortest distance from the location of the first ordered commodity may be specified on the basis of the doorway information. The first area may be a parking area which is within the first predetermined distance from the first doorway.

In this configuration, a parking area at a distance which is as short as possible for a delivery of an ordered commodity is determined as the parking location at the store having a plurality of doorways, and thus, the configuration attains an efficient delivery of the ordered commodity.

(8) In the information processing method according to any one of (1) to (7) above, the store may have a plurality of doorways. The ordered commodity information may indicate a plurality of the ordered commodities. In the acquiring, commodity location information indicating respective locations of the commodities in the store, doorway information indicating respective locations of the doorways, and weight information about each of the commodities may be further acquired. In the determining, a second ordered commodity having a weight exceeding a predetermined weight among the ordered commodities may be specified on the basis of the weight information, and a third doorway which is at a shortest distance from a location of the second ordered commodity may be specified on the basis of the commodity location information and the doorway information. The first area may be a parking area which is within the first predetermined distance from the third doorway.

In this configuration, a parking area at a distance which is as short as possible for a delivery of a heavy ordered commodity is determined as the parking location at the store having a plurality of doorways, and thus, the configuration attains an efficient delivery of the ordered commodity.

(9) In the information processing method according to any one of (1) to (8) above, the specific commodity may include at least one of a commodity having an attribute of requiring a rapid delivery to the user and a commodity having an attribute of putting a large burden on a clerk for a delivery to the user.

This configuration attains an efficient delivery of each of the commodity requiring a quick delivery to the user and the commodity which puts a large burden on the clerk for the delivery to the user.

(10) In the information processing method according to any one of (1) to (9) above, the specific commodity may include at least one of a fresh food, a frozen food, a precision machine, and a large commodity.

This configuration attains an efficient delivery of each of the fresh food, the frozen food, the precision machine, and the large commodity.

(11) In the information processing method according to any one of (1) to (10) above, the output information may include display data of a display screen image showing the parking location which is in the administrative region and is indicated by the parking location information.

This configuration enables rapid grasp of a parking location in the administrative region.

(12) In the information processing method according to any one of (1) to (11) above, the output information may include display data of a display screen image showing a location of the ordered commodity in the store.

This configuration enables rapid grasp of a location of the ordered commodity.

(13) In the information processing method according to any one of (1) to (12) above, the output information may include display data of a display screen image showing a treatment of the store for the ordered commodity from the entry of the user into the administrative region to a delivery of the ordered commodity to the user.

This configuration enables notification of a state of the store for the user waiting for the delivery of the ordered commodity.

(14) In the information processing method according to any one of (1) to (13) above, the output information may include display data of a display screen image showing a current location of a clerk delivering the ordered commodity in the store.

This configuration allows the clerk to grasp a location thereof in the store and allows the user to grasp the state of the clerk.

(15) In the information processing method according to any one of (1) to (14), the output information may be output to a user terminal carried by the user and a store terminal carried by a clerk of the store.

This configuration provides the user and the clerk with the output information including the parking location information, and thus allows the user to park the vehicle at the designated parking location and allows the clerk to deliver the ordered commodity to the parking location.

(16) In the information processing method according to any one of (1) to (15), the memory may hold a user database associating the user ID and a vehicle number with each other. In the acquiring, a vehicle image may be acquired by photographing the vehicle in the entry into the administrative region by the camera, the vehicle number may be specified from the vehicle image, and the entry information may be determined to be acquired when the user ID associated with the specified vehicle number is specified from the user database.

This configuration enables automatic detection of the entry of the vehicle of the user into the administrative region of the store.

(17) An information processing device in another aspect of the disclosure is an information processing device that provides information about delivery of commodities at a store. The information processing device includes: an acquisition part that acquires entry information indicating an entry of a user into an administrative region of the store and including a user ID, and ordered commodity information indicating an ordered commodity associated with the user ID; a determination part that determines location information about a parking location for the user to park a vehicle as parking location information on the basis of parking information including location information about parking locations in a parking place in the administrative region and the ordered commodity information, the parking information and the commodity information being held in a memory; and an output part that outputs output information including the parking location information.

This configuration makes it possible to provide an information processing device that enables an efficient delivery of a commodity in a parking place.

(18) An information processing program in another aspect of the present disclosure is an information processing program for providing information about delivery of commodities at a store. The information processing program includes causing the computer to execute: acquiring entry information indicating an entry of a user into an administrative region of the store and including a user ID, and ordered commodity information indicating an ordered commodity associated with the user ID; determining location information about a parking location for the user to park a vehicle as parking location information on the basis of parking information including location information about parking locations in a parking place in the administrative region and the ordered commodity information, the parking information and the commodity information being held in a memory; and outputting output information including the parking location information.

This configuration makes it possible to provide an information processing program for achieving an efficient delivery of a commodity in a parking place.

This disclosure can be realized as an information processing system caused to operate by the information processing program as well. Additionally, it goes without saying that the computer program is distributable as a non-transitory computer readable storage medium like a CD-ROM, or distributable via a communication network like the Internet.

Each of the embodiments which will be described below represents a specific example of the disclosure. Numeric values, shapes, constituent elements, steps, and the order of the steps described below in each embodiment are mere examples, and thus should not be construed to delimit the disclosure. Moreover, constituent elements which are not recited in the independent claims each showing the broadest concept among the constituent elements in the embodiments are described as selectable constituent elements. The respective contents are combinable with each other in all the embodiments.

### First Embodiment

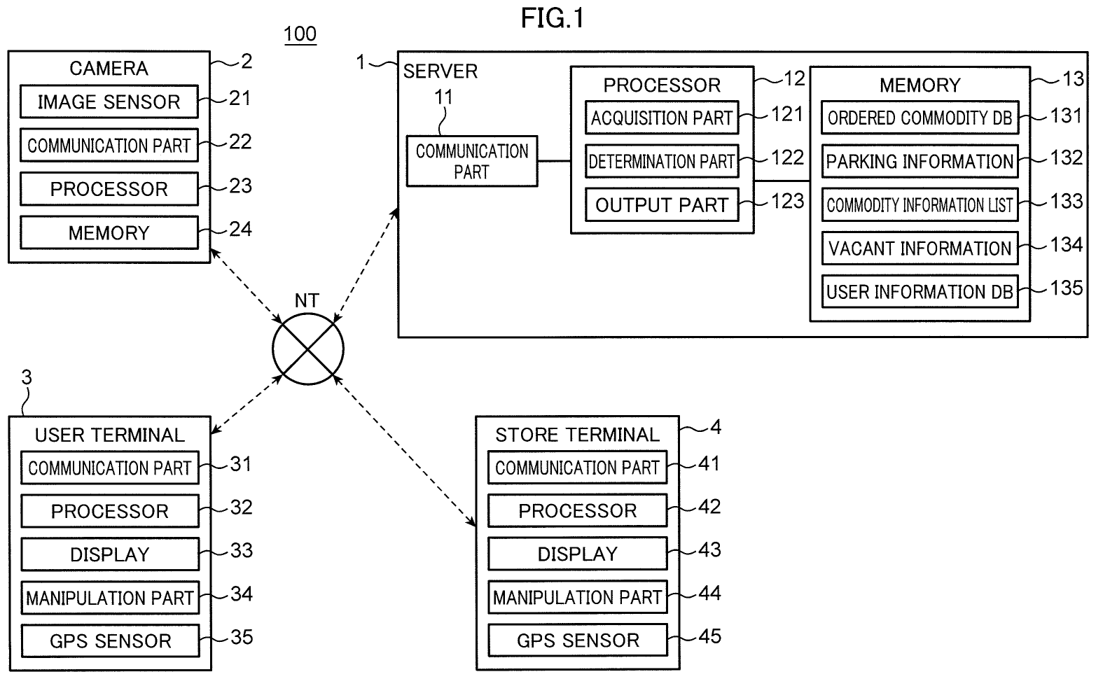

FIG. 1 is a block diagram showing an example of an overall configuration of an information processing system 100 in a first embodiment of the present disclosure. The information processing system 100 includes a server 1, a camera 2, a user terminal 3, and a store terminal 4. The server 1, the camera 2, the user terminal 3, and the store terminal 4 are communicably connected to one another via a network NT. The network NT includes, for example, a wide area network having the internet and a mobile phone communication network.

The server 1 includes, for example, a cloud server including a computer.

The camera 2 is arranged, for example, around a doorway to an administrative region of a store. Specifically, the camera 2 is arranged at a position suitable for photographing a vehicle which enters a parking place in the administrative region through the doorway. The camera 2 photographs the doorway in a predetermined frame cycle, and sends acquired image information to the server 1 in a predetermined frame cycle.

The store means a store where a user having purchased a commodity online receives the commodity. The administrative region of the store includes a building of the store and a parking place adjacent to the building. A plurality of commodities is arrayed in the building of the store. The building of the store further includes a repository that stores commodities.

The user terminal 3 is, for example, a mobile information terminal or personal digital assistant carried by the user. The mobile information terminal includes, for example, a smartphone or a tablet computer. The user terminal 3 may be formed of an in-vehicle terminal provided in the vehicle (not shown) which the user drives. The in-vehicle terminal is, for example, a car navigation system.

The store terminal 4 is, for example, a mobile information terminal carried by a clerk of the store.

Next, the configuration of the server 1 will be described in detail.

The server 1 includes a communication part 11, a processor 12, and a memory 13. The communication part 11 includes, for example, a communication circuit connecting the server 1 to the network NT. The communication part 11 receives image information from the camera 2. The communication part 11 sends, to the user terminal 3 and the store terminal 4, output information including parking location information indicating a parking location for the vehicle. The processor 12 includes, for example, a CPU. The processor 12 has an acquisition part 121, a determination part 122, and an output part 123. Each of the acquisition part 121 to the output part 123 comes into effect when the CPU executes an information processing program. Each of the acquisition part 121 to the output part 123 may be formed of a dedicated electric circuit, such as an ASIC.

The acquisition part 121 acquires entry information indicating an entry of the user into the administrative region of the store and including a user ID. The acquisition part 121 further acquires, from an ordered commodity database 131 in the memory 13, ordered commodity information which is associated with the user ID in the entry information and indicates an ordered commodity.

For instance, the acquisition part 121 specifies, as vehicle image information, image information indicating the vehicle in the entry into the administrative region of the store among information sent from the camera 2. In a success of detection of a vehicle number from the specified vehicle image information and specifying of the user ID associated with the detected vehicle number from the ordered commodity database 131, the acquisition part 121 may acquire the entry information by generating entry information including the specified user ID.

For instance, the acquisition part 121 determines whether the image information indicates a vehicle which enters the administrative region by applying image recognition processing to the image information sent from the camera 2. The acquisition part 121 may specify the image information as the vehicle image information when the image information is determined to indicate the vehicle. Adoptable examples of the image recognition processing include processing using a classifier to detect a vehicle and an advancing direction of the vehicle from the image information. The acquisition part 121 acquires a vehicle label and an advancing direction label of the vehicle by inputting the image information into the classifier. The acquisition part 121 may specify the image information as the vehicle image information when the vehicle label is acquired and the advancing direction label indicates a direction in which the vehicle enters the administrative region. The classifier is prepared in advance through machine learning of vehicle image information given a bounding box showing the vehicle and an advancing direction of the vehicle.

The acquisition part 121 may extract a domain showing a vehicle registration plate from a vehicle image indicated by the vehicle image information, and detect a vehicle number by applying character recognition processing to the domain. Specifically, in the disclosure, the vehicle number includes, for example, a character string given on the vehicle registration plate.

The acquisition part 121 may acquire the entry information by another way in place of the way using the image information. For instance, the acquisition part 121 may acquire, as entry information, information sent from the user terminal 3 and including a user ID when a vehicle enters an administrative region of a store. In this case, the user terminal 3 may send the entry information to the server 1 on receipt of an input instruction of telling the entry from the user in the entry of the vehicle into the administrative region. Alternatively, the user terminal 3 may send entry information when detecting the entry of the vehicle into the administrative region of the store on the basis of location information about the terminal and location information about the store.

The determination part 122 determines location information about a parking location for the user to park a vehicle as parking location information on the basis of parking information 132 stored in the memory 13 and the commodity information acquired by the acquisition part 121. The parking information includes location information about parking locations in the parking place in the administrative region, and will be described in detail later.

In the embodiment, the parking place includes a first area which is within a first predetermined distance from the store. The determination part 122 determines, on the basis of a commodity information list 133 held in the memory 13 and showing each of the commodities in the store, whether the ordered commodity includes a specific commodity, and determines location information about the first area as the parking location information when the ordered commodity is determined to include the specific commodity. By contrast, the determination part 122 determines location information about a second area which is different from the first area as the parking location information when determining that the ordered commodity includes no specific commodity. The second area is a distance exceeding the first predetermined distance away from the store. The first predetermined distance takes an appropriate value, such as 5 m, 10 m, and 15 m.

The output part 123 outputs output information including the parking location information determined by the determination part 122. The output part 123 may output the output information to, for example, the user terminal 3 and the store terminal 4. The output part 123 may output the output information by using the communication part 11.

The memory 13 includes a non-volatile storage device. The memory 13 stores the ordered commodity database 131, the parking information 132, the commodity information list 133, vacant information 134, and a user information database 135.

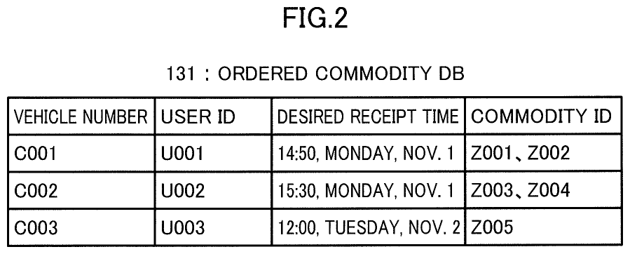

FIG. 2 is a table showing an example of a data configuration of the ordered commodity database 131. The ordered commodity database 131 includes a vehicle number field, a user ID field, a desired receipt time field, and a commodity ID field, and stores relevant information in the fields in association with one another. In the ordered commodity database 131, one record is associated with one order. The information indicating the one order represents ordered commodity information.

A vehicle number is an identifier of a vehicle owned by a user having ordered a commodity. The vehicle number includes, for example, a character string given on a vehicle registration plate of the vehicle. Here, the vehicle number is simply expressed by using a symbol string, such as “C001”, for convenience of explanation.

A user ID is an identifier of the user having ordered the commodity. The user ID may include, for example, a name or a symbol string registered in advance.

A desired receipt time indicates a time at which a user desires to receive a commodity at a store. The desired receipt time is input by the user at the time of ordering the commodity. In the order associated with the record in the first row, the desired receipt time indicates 14:00 on Monday on November 1^{st}.

A commodity ID is an identifier of the commodity ordered by the user. The order associated with the record in the first row shows two commodities ordered by the user. The record hence has registration of commodity IDs “Z001” and “Z002” of these commodities.

Such an order as registered in the ordered commodity database 131 is made online by a user on the Internet. The user uses a user terminal 3 thereof to make an access to an order site of a store, and conducts a manipulation of ordering a desired commodity and a manipulation of inputting a desired receipt time. In this manner, order information associating the user ID, the desired receipt time, and the commodity ID with one another is sent to the server 1. The server 1 having received the order information creates a new record in the ordered commodity database 131, and registers, in the new record, the user ID, the desired receipt time, and the commodity ID included in the order information. It is noted here that the user inputs the vehicle number in advance at initial registration on the online site, and the server 1 causes the memory 13 to store the user information database 135 associating the user ID and the vehicle number with each other. Hence, the server 1 may specify the vehicle number associated with the user ID included in the order information with reference to the user information database 135 and record the specified vehicle number in a vehicle number field of the newly created record.

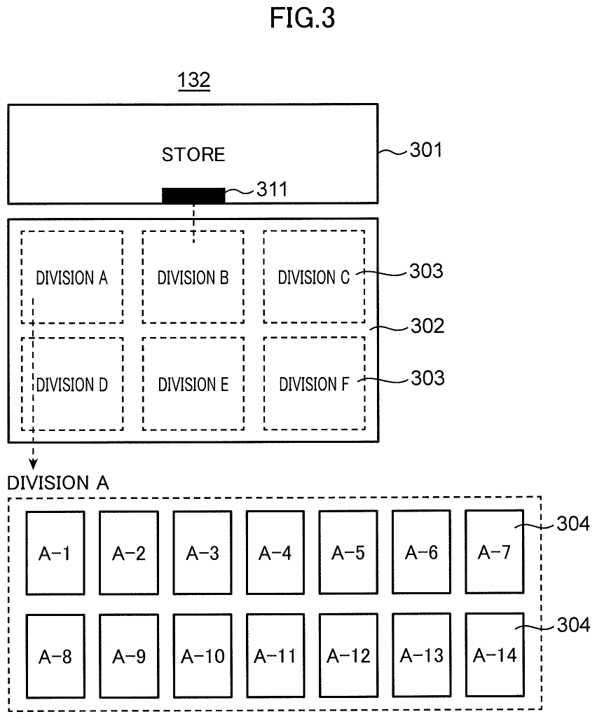

FIG. 3 is an illustration of a first example of the parking information 132. The parking information 132 is information obtained by mapping a location of a store 301 and a location of a parking place 302 on, for example, a two-dimensional coordinate space defined by an X-axis and a Y-axis. The parking information 132 defines a coordinate of respective locations of the store 301, a doorway 311, and the parking place 302.

The parking place 302 includes a plurality of divisions 303. In this example, the parking place 302 includes six divisions 303 from a division A to a division F. Each of the divisions 303 has a plurality of parking spaces 304. Each of the parking spaces 304 is a space for parking one vehicle. In this example, the division A has fourteen parking spaces 304 from A-1 to A-14. The parking information 132 indicates respective mapped locations of the divisions 303 and the parking spaces 304. The parking place 302 may include a multi-story parking garage or multi-storey car park. In this case, the parking information 132 is formed of a three-dimensional space defined by an X-axis, a Y-axis, and additionally a Z-axis denoting a floor of the parking garage.

The three divisions 303 from the division A to the division C correspond to an example of the first area. The three divisions 303 from the division D to the division F correspond to an example of the second area. When an ordered commodity includes a specific commodity, location information about the division A to the division C is determined as parking location information. For instance, a label indicating a division associated with each of the divisions 303 from the division A to the division C is usable as the parking location information. Here, each division 303 in the actual parking place 302 is displayed with an associated label indicating the division. Therefore, a user and a clerk having checked the parking location information can easily confirm where a parking location for a vehicle actually is.

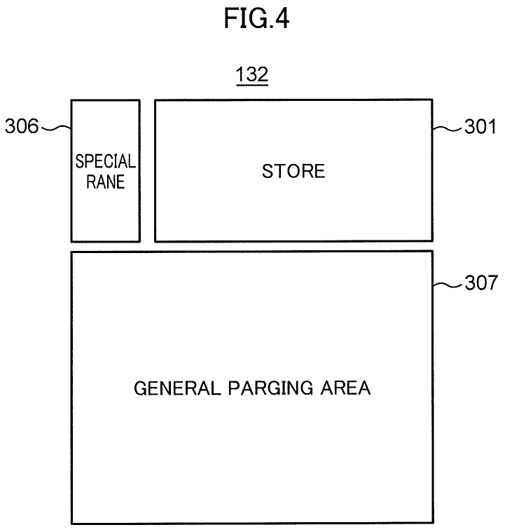

FIG. 4 is a table showing a second example of the parking information 132. The parking information 132 in the second example differs from the parking information 132 in the first example in that a location of a parking place divided into a general parking area 307 and a special lane 306 is mapped on a two-dimensional or three-dimensional space. The special lane 306 corresponds to the first area and the general parking area 307 corresponds to the second area. When an ordered commodity includes a specific commodity, location information about the special lane 306 is determined as parking location information. In this case, for instance, a label indicating the special lane 306 is usable as the parking location information. Here, the special lane 306 in the actual parking place 302 is displayed with the label indicating the special lane 306. Therefore, a user and a clerk having checked the parking location information can easily confirm where a parking location for a vehicle actually is.

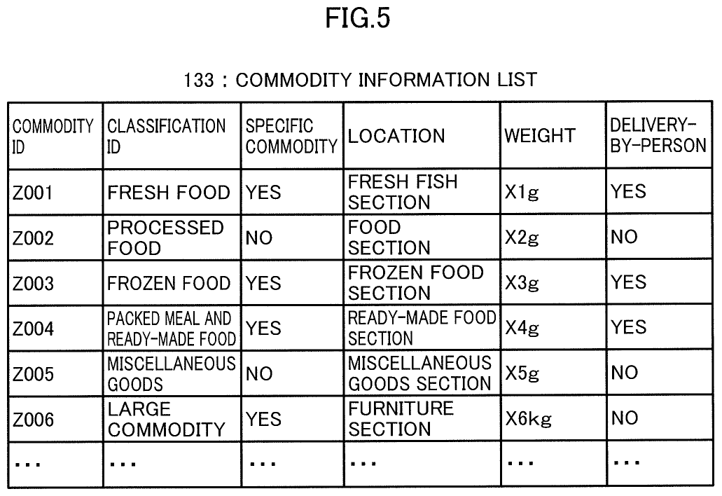

FIG. 5 is a table showing an example of a data configuration of the commodity information list 133. The commodity information list 133 is a database for registration of commodities in the store 301, i.e., commodities which the store 301 sells. In the commodity information list 133, one record is associated with one kind of commodity. The commodity information list 133 includes a commodity ID field, a classification ID field, a specific commodity field, a location field, a weight field, and a delivery-by-person field. A commodity ID is an identifier uniquely specifying an item number of a commodity. The item number of the commodity includes information indicating a kind of the commodity, e.g., a carrot, a lettuce, or other kind. A classification ID is an identifier uniquely specifying each of classifications defined depending on features of each commodity. Examples of the classification ID shown here include a fresh food, a processed food, a frozen food, a packed meal and a ready-made food, miscellaneous goods, and a large commodity.

A specific commodity includes a commodity having an attribute of requiring a rapid delivery to a user and a commodity having an attribute of putting a large burden on a clerk for a delivery to the user. Examples of the commodity having the attribute of requiring a rapid delivery to a user include a fresh food and a frozen food. The commodity having the attribute of putting a large burden on a clerk for a delivery to the user represents a commodity requiring a cautious transport and delivery due to fragility or other reason, e.g., a precision machine, a glass product, and a large commodity. Examples of the large commodity include a piece of furniture, a refrigerator, a washing machine, and a television.

The location field has registration of commodity location information indicating a location of a commodity in the store 301, such as a fresh fish section and a food section. The weight field has registration of a weight of each commodity. The delivery-by-person field has registration of information indicating whether each commodity is a commodity which requires a delivery by a person or a clerk, that is, a delivery-by-person commodity, or a commodity which is deliverable by a delivery machine without a person, that is, a machine deliverable commodity. Here, the delivery-by-person commodity is registered as “YES”, and the machine deliverable commodity is registered as “NO”.

In the example in FIG. 5, a specific commodity field for a commodity belonging to the specific commodity has registration of “YES” and a specific commodity field for a commodity not belonging to the specific commodity has registration of “NO”. In the example in FIG. 5, each of the fresh food, the frozen food, the packed meal and the ready-made food, and the large commodity is defined as the specific commodity, and each of the processed food and the miscellaneous goods is not defined as the specific commodity. The classifications of the commodities listed here are just examples, and may include another classification of another commodity. The classifications of the commodities each defined as the specific commodity are also just examples, and another classification of another commodity may belong to the specific commodity.

Referring back to FIG. 1, the vacant information 134 indicates a vacant space being a parking space 304 which is vacant without being occupied by a vehicle in a parking place. For instance, the vacant information 134 has registration of information about an occupancy by a parked vehicle or a vacancy for each parking space in the parking place. The server 1 may detect a vacant space on the basis of sensing data sent from a parking sensor arranged in each parking space 304 to detect an occupancy by a parked vehicle or a vacancy, and update the vacant information 134 on the basis of a result of the detection. The parking sensor may include, for example, an object sensor, and may send sensing data indicating an occupancy by a parked vehicle to the server 1 on detection of the parked vehicle and send sensing data indicating a vacancy to the server 1 on detection of the vacancy. The server 1 may detect the occupancy by the parked vehicle or the vacancy by applying image processing to image information indicating a parking place photographed by a camera provided in the parking place. The image information indicating the parking place shows an image in a bird's-eye view of the entire parking place. The server 1 may extract each parking space 304 and a vehicle occupying an associated parking space 304 from the image information indicating the parking place to detect a certain parking space 304 which is vacant without being occupied by a vehicle and define the certain parking space 304 as a vacant space.

The user information database 135 is a database for registration of user information about a plurality of users having registered as users on the online site of the store 301. The user information is stored in association with a name, an address, contact information, a user ID, a vehicle number, and attribute information. Examples of the attribute information include a gender, an age, and an occupation. The user information is registered in the user information database 135, for example, when the user performs the user registration.

Heretofore, the configuration of the server 1 is described. Subsequently, the camera 2 will be described. The camera 2 includes an image sensor 21, a communication part 22, a processor 23, and a memory 24. Examples of the image sensor 21 include an imaging element, such as an CMOS image sensor. The communication part 22 includes a communication circuit connecting the camera 2 to the network NT. The processor 23 includes, for example, a CPU, and controls the camera 2. The processor 23 causes the image sensor 21 to capture an image of a doorway to the administrative region of the store 301 in a predetermined frame cycle. The processor 23 sends image information about the image captured by the image sensor 21 in the predetermined frame cycle to the server 1 by using the communication part 22. The memory 24 includes a RAM and a ROM, and is used as a working memory of the processor 23.

In the disclosure, the camera 2 may execute the specifying of vehicle image information from the image information. In this case, the processor 23 may specify the vehicle image information from the image information by using the aforementioned classifier and send the vehicle image information to the server 1 by using the communication part 22. The server 1 having received the vehicle image information may execute the above-described detection of a vehicle number from the vehicle image information.

Next, the user terminal 3 will be described. The user terminal 3 includes a communication part 31, a processor 32, a display 33, a manipulation part 34, and a GPS sensor 35. The communication part 31 includes a communication circuit connecting the user terminal 3 to the network NT. The processor 32 includes, for example, a CPU, and controls the user terminal 3. The display 33 includes, for example, a liquid crystal panel and displays various images. The manipulation part 34 includes, for example, a touch screen and a physical button to receive a manipulation from a user. The GPS sensor 35 detects a location of the user terminal 3.

Next, the store terminal 4 will be described. The store terminal 4 includes a communication part 41, a processor 42, a display 43, a manipulation part 44, and a GPS sensor 45. The communication part 41 includes a communication circuit connecting the store terminal 4 to the network NT. The processor 42 includes, for example, a CPU, and controls the store terminal 4. The display 43 includes, for example, a liquid crystal panel and displays various images. The manipulation part 44 includes, for example, a touch screen and a physical button to receive a manipulation from a clerk. The GPS sensor 45 detects a location of the store terminal 4.

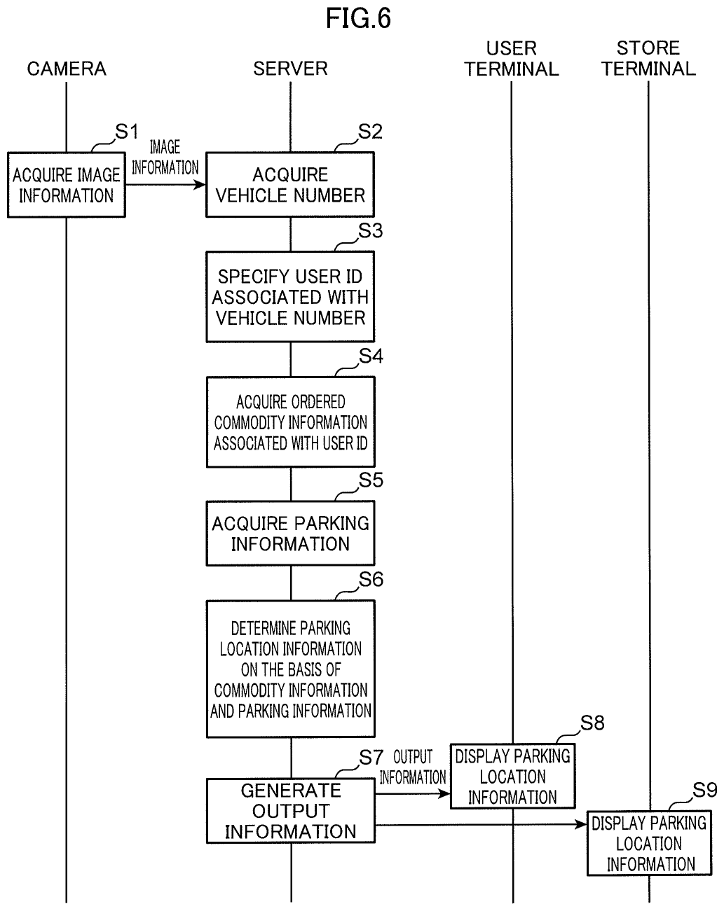

Hereinafter, a process by the information processing system 100 will be described. FIG. 6 is a flowchart showing a first example of the process by the information processing system 100 in the first embodiment. The server 1 serves as a subject of the process in the flowchart in the first example.

### Step S1

The camera 2 acquires image information by photographing a doorway to an administrative region of a store and sends the acquired image information to the server 1.

### Step S2

The acquisition part 121 of the server 1 acquires a vehicle number by applying the aforementioned image processing to the sent image information.

### Step S3

The acquisition part 121 of the server 1 specifies a user ID associated with the vehicle number with reference to the ordered commodity database 131. In detail, the acquisition part 121 retrieves, from the ordered commodity database 131, ordered commodity information associated with the vehicle number from a current time to a time after a predetermined period therefrom (e.g., one hour, three hours, and other period), the ordered commodity information designating “today” as a desired receipt time. In a success of retrieval of the ordered commodity information satisfying this condition, the acquisition part 121 determines a user indicated by the user ID associated with the vehicle number in the ordered commodity database 131 as a user who desires receipt today, and specifies the user ID associated with the vehicle number. At this time, the acquisition part 121 generates entry information including the user ID. By contrast, in a failure of retrieval of the ordered commodity information satisfying the condition from the ordered commodity database 131, no entry information is generated.

In the case where the user terminal 3 detects an entry of a vehicle into the administrative region of the store in the above-described manner, the acquisition part 121 may acquire entry information sent from the user terminal 3.

In the example in FIG. 2, the vehicle having the vehicle number “C001” enters the administrative region of the store 301 at 14:00 on November 1^{st}. In this regard, the ordered commodity database 131 has registration of ordered commodity information indicating the desired receipt time “14:50 on Monday on November 1^{st}” falling within one hour (predetermined period) from 14:00 for the vehicle number “C001”. The acquisition part 121 thus specifies the user ID “U001” associated with the vehicle number “C001”. The acquisition part 121 avoids generating entry information when failing to specify a user ID associated with a vehicle number from the ordered commodity database 131.

### Step S4

The acquisition part 121 of the server 1 acquires ordered commodity information associated with the user ID included in the entry information with reference to the ordered commodity database 131. In detail, in step S3, the acquisition part 121 acquires, as the ordered commodity information associated with the user ID, ordered commodity information retrieved from the ordered commodity database 131 and satisfying the condition.

### Step S5

The acquisition part 121 of the server 1 acquires parking information 132 from the memory 13.

### Step S6

The determination part 122 of the server 1 determines parking location information on the basis of the ordered commodity information acquired in step S4 and the parking information 132. Step S6 will be described in detail later.

### Step S7

The output part 123 of the server 1 generates output information including the determined parking location information and outputs the output information to the user terminal 3 and the store terminal 4.

### Step S8

The user terminal 3 displays the parking location information included in the output information on the display 33.

### Step S9

The store terminal 4 displays the parking location information included in the output information on the display 43.

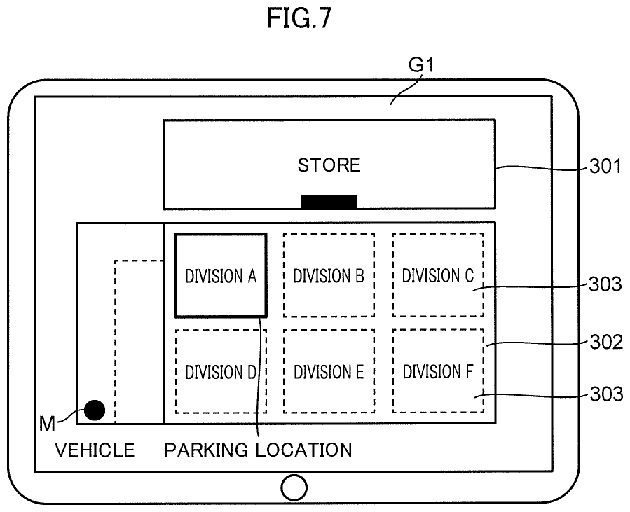

FIG. 7 is an illustration of a display screen image G1 in a first example displaying output information on the display of each of the user terminal 3 and the store terminal 4. The display screen image G1 includes a map image of the store 301 and the parking place 302. The display screen image G1 shows a location of a vehicle M in real time. The location of the vehicle M is updated on the basis of location information about the user terminal 3 detected by the GPS sensor 35 of the user terminal 3. In this example, the division A is determined as a parking location and a display object denoting the division A is displayed in a display mode which is different from a display mode for a display object indicating another division 303. Adoptable examples of the display object include an outline of each division 303. In this example, the display object for the division A is displayed in a color which is different from a color of the display object for another division 303. However, this is just an example, and the display object for the division A may be displayed in a flashing manner. Such displaying allows the user to easily confirm a specific division 303 for parking the vehicle M. The displaying further allows a clerk to easily confirm the specific division 303 for a delivery of an ordered commodity.

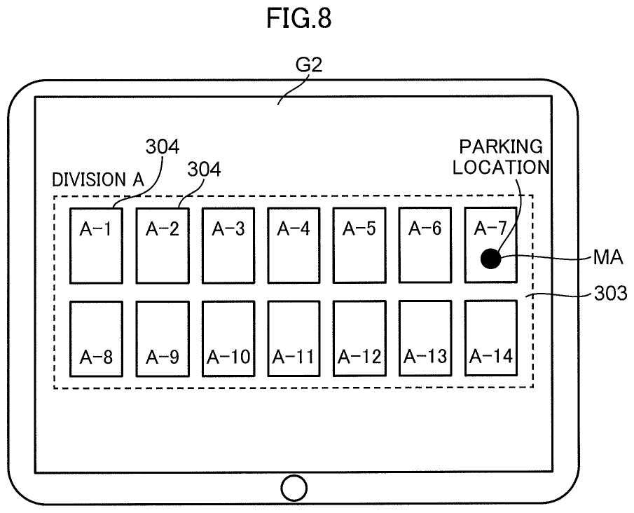

FIG. 8 is an illustration of a display screen image G2 in a second example displaying output information on the display of each of the user terminal 3 and the store terminal 4. Displaying of the display screen image G2 may be triggered by an input of a manipulation of touching the display object for the division A on the display screen image G1. The display screen image G2 is displayed when a parking location is determined on the basis of a unit of a parking space 304. The display screen image G2 shows a label for a division, i.e., “division A” here, and a map image of the division A. The display screen image G2 shows a display object indicating each of the parking spaces 304 in the division A. An image showing an outline of each parking space 304 is used as the display object. In this example, the parking space “A-7” in the division A is determined as a parking location, and a mark MA is superimposed on the display object for the parking space 304 and displayed. Further, the message “parking location” is superimposed and displayed via a leader line from the mark MA. Such displaying allows the user to easily confirm a specific parking space 304 for parking the vehicle M. The displaying further allows the clerk to easily confirm the specific parking space for the delivery of the ordered commodity.

Each of the display screen images G1, G2 displayed on the store terminal 4 may show user information, commodity information about an ordered commodity, and vehicle information. User information may include information indicating a picture, a name, and an age of the user. Commodity information may include information indicating a commodity name and the number of commodities. Vehicle information may include information indicating a vehicle number and a vehicle type.

Each of the display screen images G1, G2 displayed on the user terminal 3 may show a treatment of the store for an ordered commodity from an entry of the user into an administrative region to a delivery of the ordered commodity to the user. Examples of the treatment include a state of “picking up”, a state of “bagging or wrapping”, and a state of “arriving soon”. The state of “picking up” represents a treatment of picking up the ordered commodity by the clerk. The state of “bagging or wrapping” represents a treatment of bagging or wrapping the ordered commodity having been picked up by the clerk. The state of “arriving soon” represents a treatment of delivering the wrapped ordered commodity to the parking location by the clerk. The output part 123 may determine each treatment from the location information about the store terminal 4 and update each of the display screen images G1, G2 to reflect a result of the determination. For instance, when the location information about the store terminal 4 carried by a clerk who is in charge of a picking-up operation shows a state of the clerk moving at a predetermined speed or faster in the store for a certain time period or longer, the output part 123 may determine the treatment as the state of “picking up”. When the location information about the store terminal 4 of the clerk shows a state of staying at a predetermined bagging or wrapping section for a certain time period or longer, the output part 123 may determine the treatment as the state of “bagging or wrapping”. When the location information about the store terminal 4 of the clerk shows a state of moving outside the store 301, the output part 123 may determine the treatment as the state of delivering.

Each of the display screen images G1, G2 displayed on the user terminal 3 may show a mark indicating a current location of the clerk in real time. In this case, the output part 123 may update a display position of the mark on the basis of the location information about the store terminal 4.

Each of the display screen images G1, G2 displayed on the user terminal 3 and the store terminal 4 may show a location of the ordered commodity. In this case, on each of the display screen images G1, G2, a display object indicating the location of the ordered commodity may be superimposed on a map image of the store 301 and displayed.

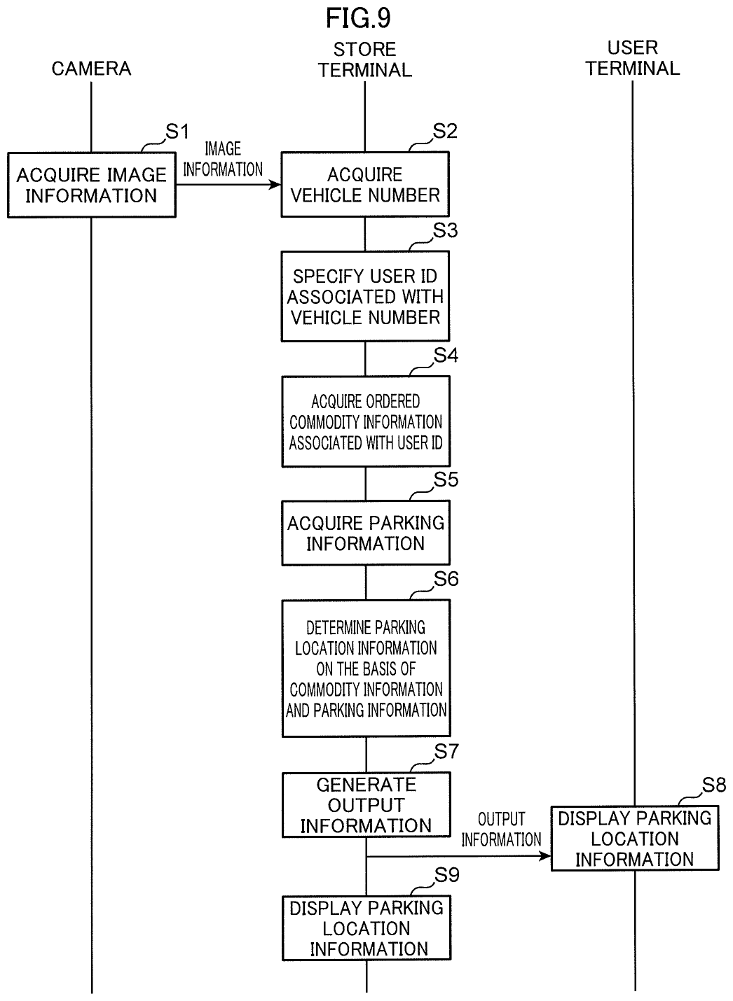

FIG. 9 is a flowchart showing a second example of the process by the information processing system 100 in the first embodiment. The store terminal 4 serves as a subject of the process in the flowchart in the second example in place of the server 1 which is omitted. In the flowchart shown in FIG. 9, steps which are the same as the steps in FIG. 6 are given the same reference numerals and signs. It is noted here that image information is sent from the camera 2 to the store terminal 4 in step S1, and the store terminal 4 executes steps S2 to S7.

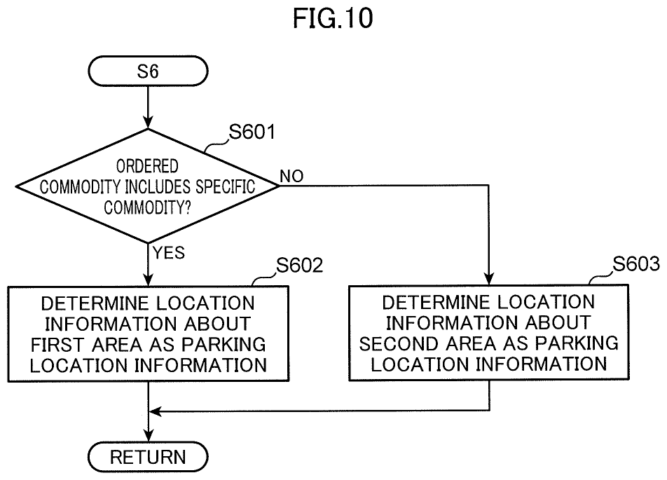

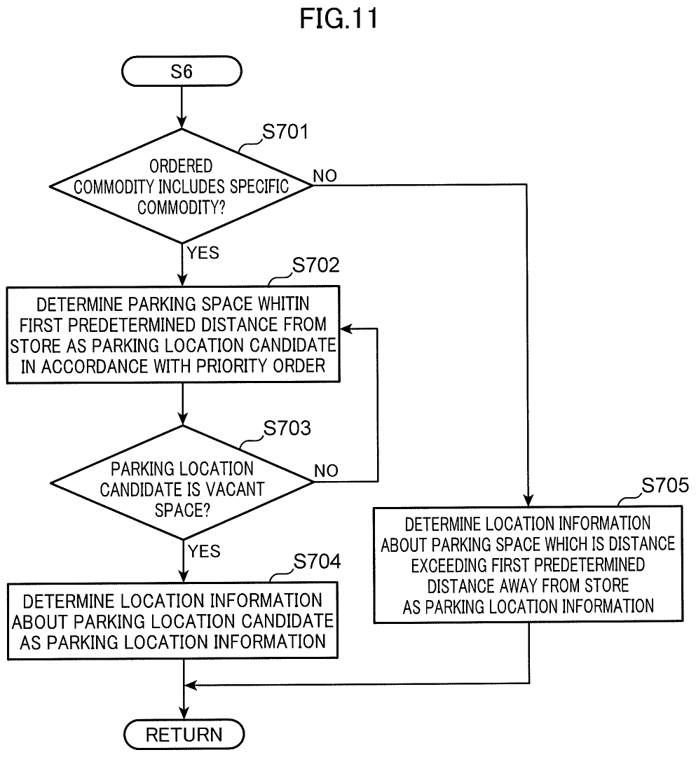

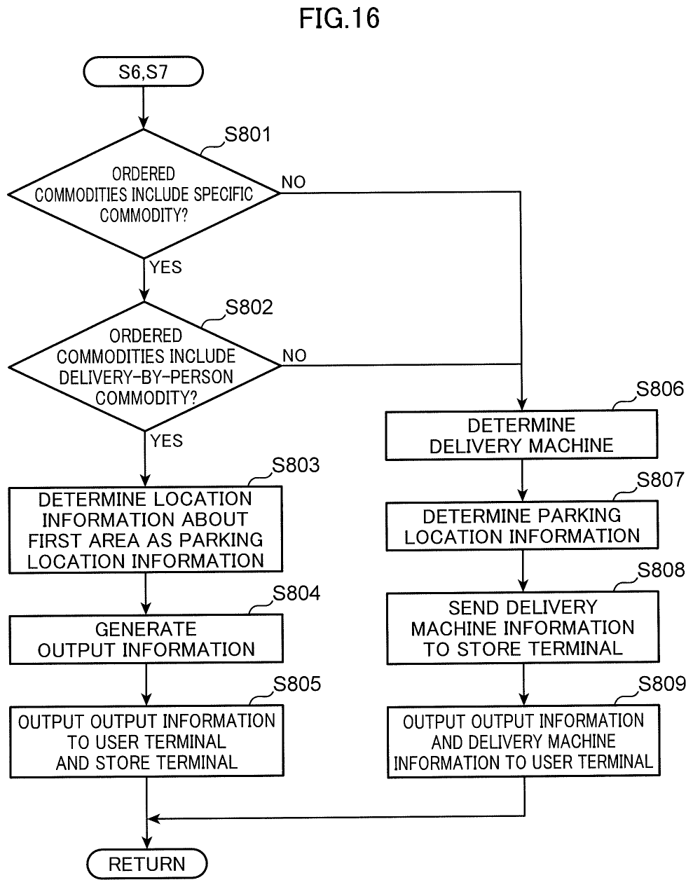

FIG. 10 is a flowchart showing a first example of step S6 in FIG. 6 and FIG. 9. Although the server 1 is defined as the subject of the relevant steps in the description below, the store terminal 4 may serve as the subject of the steps. This is applicable to the flowcharts in FIG. 11 and FIG. 16.

### Step S601

The determination part 122 of the server 1 determines whether the ordered commodity indicated by the ordered commodity information acquired in step S4 includes a specific commodity with reference to the commodity information list 133. In a case where the ordered commodity information in the first row in FIG. 2 is acquired and at least one of the commodities associated with the commodity IDs “Z001” and “Z002” is registered as a specific commodity in the commodity information list 133, the determination part 122 determines that ordered commodities include a specific commodity. By contrast, in a case where neither of the commodities associated with the commodity IDs “Z001” and “Z002” is registered as the specific commodity in the commodity information list 133, the determination part 122 determines that the ordered commodities include no specific commodity.

### Step S602

The determination part 122 determines, as parking location information, location information about the first area which is within a first predetermined distance from the store 301 with reference to the parking information 132. In the example in FIG. 3, the first area includes the division A to the division C each defined in advance as a division which is within the first predetermined distance from the doorway 311.

### Step S603

The determination part 122 determines, as the parking location information, location information about the second area which is a distance exceeding the first predetermined distance away from the store 301 with reference to the parking information 132. In the example in FIG. 3, the second area includes the division D to the division F each defined in advance as a division which is a distance exceeding the first predetermined distance away from the doorway 311.

The first area may be the division B being a division 303 which is at a shortest distance from the doorway 311. In this case, the second area is a division 303 other than the division B.

In the example in FIG. 4, the special lane 306 is determined as the first area. In this case, the general parking area 307 is determined as the second area.

In a case where the parking place 302 includes a multi-story parking garage, a predetermined floor and a lower floor or lower floors of the parking place 302 may be determined as the first area. In this case, a floor or floors exceeding the predetermined floor of the parking place 302 are determined as the second area.

The determination part 122 may determine the parking location information on the basis of climate information. For instance, location information about a multi-story parking garage is determined as the parking location information when the climate information indicates an unfavorable weather like rain, and location information about a single-floored parking place as the parking location information when the climate information does not indicate such an unfavorable weather.

FIG. 11 is a flowchart showing a second example of step S6 in FIG. 6 and FIG. 9. In the second example, the parking location information is determined on the basis of a unit of a parking space 304.

### Step S701

Step S701 is the same as step S601.

### Step S702

The determination part 122 determines a parking space 304 which is within the first predetermined distance from the store 301 as a parking location candidate in accordance with a priority order. For instance, the determination part 122 may determine, as the parking location candidate, a parking space 304 having a higher rank in the priority order among a plurality of predefined parking spaces 304 which are within the first predetermined distance from the doorway 311. Each of the parking spaces 304 is given a predefined rank in the priority order. The priority order is defined in such a manner that a parking space 304 at a shorter distance from the doorway 311 has a higher rank.

### Step S703

The determination part 122 determines whether the parking location candidate is a vacant space with reference to the vacant information 134. When the parking location candidate is a vacant space (YES in step S703), the process proceeds to step S704. When the parking location candidate is not a vacant space (NO in step S703), the process returns to step S702.

### Step S704

The determination part 122 determines location information about the parking location candidate as the parking location information. In this case, the parking location candidate serves as the first area.

### Step S705

The determination part 122 determines, as the parking location information, location information about a parking space 304 which is a distance exceeding the first predetermined distance away from the store 301. In this case, the determination part 122 may extract vacant spaces from among a plurality of parking spaces 304 each being at a distance exceeding the first predetermined distance with reference to the vacant information 134, and determine one parking space 304 from the extracted vacant spaces at random.

The determination of the parking location on the basis of a unit of a parking space 304 leads to achieved determination of a parking location in more detail.

Conclusively, in the first embodiment, when a user having come to receive an ordered commodity enters the administrative region of the store 301, location information about a parking location in a parking place for the user to park is determined as parking location information on the basis of parking information indicating parking locations in the parking space and ordered commodity information, and the parking location information is output. This achieves an efficient delivery of a commodity in the parking place.

### Second Embodiment

A second embodiment shows a way of determining a parking location in a case where a store 301 has a plurality of doorways 311. In the second embodiment, constituent elements which are the same as those in the first embodiment are given the same reference numerals and signs, and thus, description therefor will be omitted. Further, a configuration of an information processing system 100 in the second embodiment will be described with reference to FIG. 1.

Referring to FIG. 1, an acquisition part 121 further acquires commodity location information indicating respective locations of commodities in the store and location information or doorway information about the doorways 311. The commodity location information is acquired from a location field in a commodity information list 133. The location information about each of the doorways 311 indicates a coordinate of the doorway 311 included in parking information 132.

In the second embodiment, when an ordered commodity indicated by ordered commodity information includes a specific commodity, a determination part 122 specifies a location of the ordered commodity on the basis of the commodity location information and the ordered commodity information, and specifies, on the basis of the doorway information, a first doorway which is at a shortest distance from the specified location of the ordered commodity among the doorways 311. The determination part 122 determines, as parking location information, location information about a first area which is within a first predetermined distance from the first doorway.

By contrast, the determination part 122 determines, as the parking location information, location information about a second area which is a distance exceeding the first predetermined distance away from the first doorway when the ordered commodity indicated by the ordered commodity information includes no specific commodity.

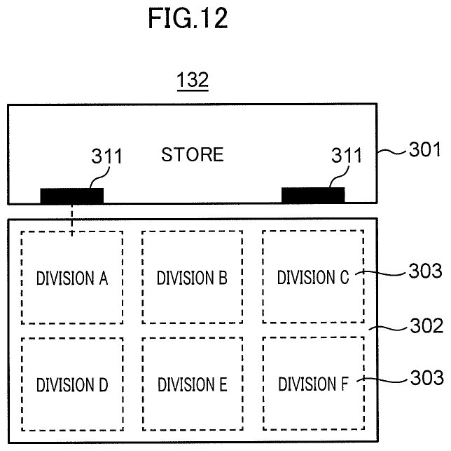

FIG. 12 is an illustration of the parking information 132 in the second embodiment of the disclosure. The store 301 has two doorways 311. In this example, the determination part 122 determines a left doorway 311 as the doorway 311 which is at the shortest distance from the location of the ordered commodity included in the ordered commodity information. The determination part 122 thus specifies the left doorway 311 as the first doorway. The determination part 122 further determines, as parking location information, location information about a division A defined in advance as a division 303 which is within the first predetermined distance from the first doorway. For instance, the determination part 122 may define a coordinate of the center of the doorway as the location of the doorway 311.

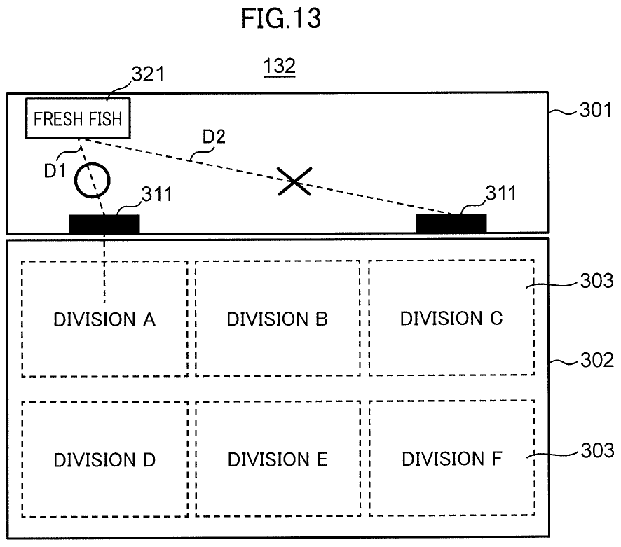

FIG. 13 is an illustration of details of the parking information 132 in the second embodiment of the disclosure. The parking information 132 indicates a mapped layout of the store 301. In this example, the ordered commodity is located in a fresh fish section 321. The determination part 122 calculates a distance D1 between the fresh fish section 321 and the left doorway 1 and a distance D2 between the fresh fish section 321 and a right doorway 311. The distance D1 is shorter than the distance D2, and thus, the determination part 122 determines the left doorway 311 as the first doorway. For instance, the determination part 122 may define a coordinate of the center of a selling section as a location of the selling section.

In a case of a plurality of ordered commodities at different locations, the determination part 122 may calculate the distance D1 and the distance D2 for each of the locations of the ordered commodities. The determination part 122 then may determine the left doorway 311 as the first doorway when the number of locations of commodities each being at the distance D1 which is shorter than the distance D2 is larger and determine the right doorway 311 as the first doorway when the number of locations of commodities each being at the distance D2 which is shorter than the distance D1 is larger.

As described heretofore, in the second embodiment, in the case where the store has a plurality of doorways 311, location information about a parking area which is within the first predetermined distance from a doorway 311 near the location of the ordered commodity is determined as the parking location information. This thus enables determination of a parking area in a shorter delivery route for the ordered commodity as a parking location and attains an efficient delivery of the ordered commodity.

Although a location of an ordered commodity is in a selling section of the ordered commodity in the description above, this is just an example, and the location may be in a repository or stock section for the ordered commodity. This is applicable to embodiments to be described below.

### Third Embodiment

A third embodiment is aimed at determining a pickup route for picking up an ordered commodity by a clerk so that a moving distance of the clerk is shorter in a case where a store 301 has a plurality of doorways 311 and there is a plurality of ordered commodities. In the third embodiment, constituent elements which are the same as those in the first and second embodiments are given the same reference numerals and signs, and thus, description therefor will be omitted. Further, a configuration of an information processing system 100 in the third embodiment will be described with reference to FIG. 1.

An acquisition part 121 further acquires location information about a store terminal 4, commodity location information indicating respective locations of commodities in the store 301, and doorway information indicating respective locations of the doorways 311. The location information about the store terminal 4 represents location information about the store terminal 4 detected by a GPS sensor 45 of the store terminal 4. The store terminal 4 periodically sends the location information detected by the GPS sensor 45 to the server 1. The commodity location information is acquired from a location field in a commodity information list 133. The location information about each of the doorways 311 indicates a coordinate of the doorway 311 included in parking information 132.

When the ordered commodities indicated by the ordered commodity information include a specific commodity, a determination part 122 specifies a location of a first ordered commodity which is a distance exceeding a second predetermined distance away from the location of the store terminal 4 among the ordered commodities on the basis of ordered commodity information, the commodity location information, and the location information about the store terminal 4, and specifies, on the basis of the doorway information, a first doorway which is at a shortest distance from the location of the first ordered commodity. The second predetermined distance indicates, for example, a distance to an ordered commodity at a location which is secondly farthest from the store terminal 4 among the ordered commodities.

By contrast, the determination part 122 determines, as the parking location information, location information about a second area which is a distance exceeding a first predetermined distance away from the first doorway when the ordered commodities indicated by the ordered commodity information include no specific commodity.

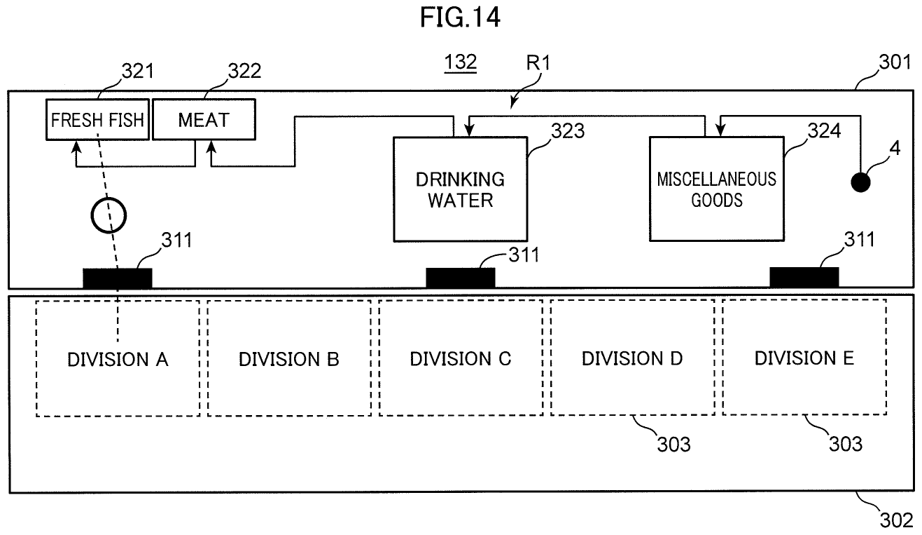

FIG. 14 is an illustration of the parking information 132 in the third embodiment of the disclosure. The parking information 132 indicates a mapped layout of the store 301. In this example, the store 301 has a left doorway 311, a center doorway 311, and a right doorway 311. The store 301 includes a fresh fish section 321, a meat section 322, a drinking water section 323, and a miscellaneous goods section 324.

In this example, the store terminal 4 is located to the right of the miscellaneous goods section 324. The ordered commodities include a fresh fish, a meat, drinking water, and a piece of miscellaneous goods.

First, the determination part 122 specifies the fresh fish, the meat, the drinking water, and the miscellaneous goods from the ordered commodity information. Each of the fresh fish and the meat is a fresh food, and hence, the determination part 122 determines that the ordered commodities include a specific commodity with reference to the commodity information list 133.

Next, the determination part 122 specifies respective locations of the ordered commodities of the fresh fish, the meat, the drinking water, and the miscellaneous goods with reference to associated location fields in the commodity information list 133. Subsequently, the determination part 122 specifies an ordered commodity located farthest from the store terminal 4 among the ordered commodities. Here, the fresh fish section 321 is farthest from the store terminal 4, and hence, the fresh fish located in the fresh fish section 321 is specified as the first ordered commodity.

Then, the determination part 122 specifies, as the first doorway, a doorway 311 which is at a shortest distance from the fresh fish section 321 among the doorways 311 with reference to the parking information 132. Here, the left doorway 311 serves as the doorway 311 which is at the shortest distance from the fresh fish section 321, and hence, the left doorway 311 is specified as the first doorway. The determination part 122 subsequently determines, as parking location information, location information about a division A defined in advance as a division 303 which is within the first predetermined distance from the first doorway.

An output part 123 may calculate route information including a route for picking up the ordered commodities in order by a clerk from the location information about the store terminal 4 and the location information about each of the ordered commodities, and add the calculated route information to the output information. For instance, the ordered commodities are defined as “A”, “B”, and “C”, and the location of the store terminal 4 is defined as “P”. In this case, the output part 123 creates routes for the ordered commodities A, B, and C from the location P serving as a start point in order. Consequently, six routes of “P-A-B-C”, “P-A-C-B”, “P-B-A-C”, “P-B-C-A”, “P-C-A-B”, and “P-C-B-A” are created. The output part 123 then specifies a route with a shortest distance among the routes, and creates the specified route as route information. In the example in FIG. 12, the route of “the store terminal 4—the miscellaneous goods section 324—the drinking water section 323—the meat section 322—the fresh fish section 321” in this order is specified as the route with the shortest distance. A pickup route R1 for picking up the commodities in this order is generated as the route information. The route information indicates, for example, display data for superimposing and displaying the pickup route R1 on a map image of the store 301 and a parking place 302. Alternatively, the route information may include a message showing the pickup route R1. The message may be, for example, display data including a message showing labels of selling sections to be visited in order for picking up.

Conclusively, in the third embodiment, a parking area at a distance which is as short as possible for a delivery of an ordered commodity is determined as a parking location at the store 301 having the plurality of doorways 311, and thus, an efficient delivery of the ordered commodity is attained.

### Fourth Embodiment

A fourth embodiment is aimed at determining a parking location at a distance which is as short as possible for a delivery of an ordered commodity which is heavy in a case where a store 301 has a plurality of doorways 311 and there is a plurality of ordered commodities.

In the fourth embodiment, constituent elements which are the same as those in the first to third embodiments are given the same reference numerals and signs, and thus, description therefor will be omitted. Further, a configuration of an information processing system 100 in the fourth embodiment will be described with reference to FIG. 1.

An acquisition part 121 further acquires commodity location information indicating respective locations of commodities in the store 301, doorway information indicating respective locations of the doorways 311, and weight information. The commodity location information is acquired from a location field in a commodity information list 133. The location information about each of the doorways 311 indicates a coordinate of the doorway 311 included in parking information 132. The weight information is acquired from a weight field in the commodity information list 133.

A determination part 122 specifies a second ordered commodity having a weight exceeding a predetermined weight among the ordered commodities on the basis of the weight information and specifies a third doorway which is at a shortest distance from a location of the second ordered commodity on the basis of the commodity location information and the doorway information. The determination part 122 determines, as parking location information, location information about a first area which is within a first predetermined distance from the third doorway. The predetermined weight indicates, for example, a weight of an ordered commodity which is secondly heaviest among the ordered commodities. The second ordered commodity may be a large commodity. The predetermined weight may be set to a specific value, e.g., 5 kg or more. When the ordered commodities include a plurality of heavier ordered commodities each having a weight exceeding the predetermined weight, the determination part 122 may specify an ordered commodity which is heaviest among the heavier ordered commodities as the second ordered commodity.

By contrast, the determination part 122 determines, as the parking location information, location information about a second area which is a distance exceeding the first predetermined distance away from the third doorway when the ordered commodities indicated by the ordered commodity information include no specific commodity, or when the ordered commodities include a specific commodity, but none of the ordered commodities has a weight exceeding the predetermined weight.

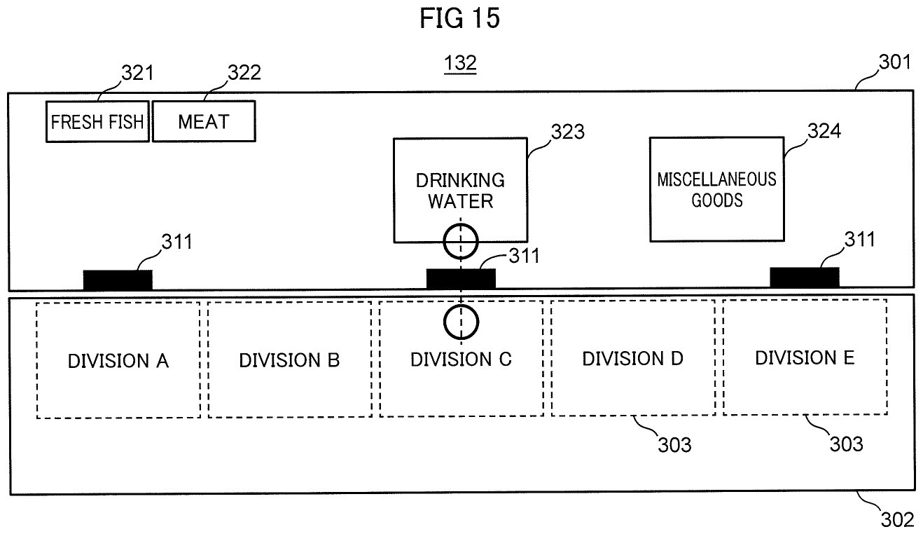

FIG. 15 is an illustration of an example of the parking information 132 in the fourth embodiment of the disclosure. In the example in FIG. 15, the ordered commodities include a piece of miscellaneous goods, drinking water, a meat, and a fresh fish. The determination part 122 specifies respective weights of the ordered commodities with reference to associated weight fields in the commodity information list 133. Next, the determination part 122 specifies, as the second ordered commodity, an ordered commodity having a weight exceeding the predetermined weight, that is, the heaviest ordered commodity, among the ordered commodities. In this example, the drinking water is the heaviest, and thus, the drinking water is specified as the second ordered commodity.

Subsequently, the determination part 122 specifies a location of the drinking water with reference to the commodity information list 133. Then, the determination part 122 specifies the center doorway 311 being a doorway which is closest to the location of the drinking water as the third doorway. The determination part 122 then determines, as parking location information, location information about a division C defined in advance as a division 303 which is within the first predetermined distance from the third doorway.

An output part 123 may calculate route information in the fourth embodiment as well as in the third embodiment. In this case, the output part 123 creates routes for the ordered commodities in order by defining a location of a store terminal 4 as a start point and defining the location of the heaviest ordered commodity as a finish point. The output part 123 may specify a route with a shortest distance among the created routes and create the specified route as route information.

Conclusively, in the fourth embodiment, a parking area at a distance which is as short as possible for a delivery of a heavy commodity is determined as a parking location at the store 301 having the plurality of doorways 311, and thus, an efficient delivery of an ordered commodity is attained.

The determination part 122 may specify the second ordered commodity in consideration of the number of ordered commodities. For instance, in a case where the ordered commodities include three packages of 3 kg of meat and two bottles of 2 kg of drinking water, the meat is specified as the second ordered commodity. In this case, the determination part 122 may calculate the total weight of the ordered commodities by multiplying the number of ordered commodities indicated by the ordered commodity information by the weight per commodity specified from the ordered commodity information list 133.

### Fifth Embodiment

A fifth embodiment is aimed at delivering an ordered commodity from a store 301 to a predetermined receipt location not by a clerk but by a delivery machine without a person. In the fifth embodiment, constituent elements which are the same as those in the first to fourth embodiments are given the same reference numerals and signs, and thus, description therefor will be omitted. Further, a configuration of an information processing system 100 in the fifth embodiment will be described with reference to FIG. 1.

In the fifth embodiment, one of the ways in the first to fourth embodiments is adoptable until determination of a parking location. A process by the server 1 after the determination of the parking location will be described below.

A determination part 122 determines a delivery machine without a person to deliver an ordered commodity for which a parking location is determined.

The delivery machine includes an autonomous mobile vehicle. The delivery machine includes a wheel, a carrier base for loading a commodity thereon, a motor that drives the wheel, a processor for driving the motor, a memory that stores delivery machine information, and a communication circuit that communicates with the server 1. The delivery machine information includes a delivery machine ID of the delivery machine. The processor controls the motor in accordance with a command from the server 1 to make the delivery machine carrying an ordered commodity thereon move to a commodity receipt location.

The command includes a control command of making the delivery machine move along a delivery route from a delivery start point in the store to the commodity receipt location. The delivery start point is, for example, located in the store 301 where a clerk loads the ordered commodity in the delivery machine. The commodity receipt location is, for example, in the vicinity of a parking location with respect to the ordered commodity. For instance, when the parking location is determined on the basis of a unit of a division 303, the commodity receipt location is in the vicinity of the determined division 303. For instance, when the parking location is determined on the basis of a unit of a parking space 304, the commodity receipt location is in the vicinity of the determined parking space 304.

An output part 123 outputs, to a store terminal 4, delivery machine information about the delivery machine determined by the determination part 122. The delivery machine has a housing on which the delivery machine ID is given, and hence, the clerk can specify the delivery machine to put the ordered commodity thereon.

The output part 123 outputs, to a user terminal 3, parking location information, the delivery machine information, and receipt location information indicating the receipt location. The user terminal 3 displays the parking location, the delivery machine ID, and the receipt location. As a result, the user can confirm the parking location, the delivery machine to deliver the ordered commodity, and the receipt location.

An acquisition part 121 acquires, from the delivery machine, loading completion information indicating completion of loading the ordered commodity.

When the acquisition part 121 acquires the loading completion information, the output part 123 outputs, to the delivery machine, a command of making the delivery machine move from the movement start point to the receipt location.

Conclusively, the fifth embodiment adopting a delivery machine without a person to deliver an ordered commodity to a user achieves a further reduction in a burden on a clerk.

### Sixth Embodiment

A sixth embodiment is aimed at determining whether to choose a clerk or a delivery machine without a person to deliver an ordered commodity depending on a kind of the ordered commodity in a case where there is a plurality of ordered commodities. In the sixth embodiment, constituent elements which are the same as those in the first to fifth embodiments are given the same reference numerals and signs, and thus, description therefor will be omitted.

FIG. 16 is a flowchart showing an example of a process by an information processing system in the sixth embodiment of the disclosure. The flowchart in FIG. 16 shows steps S6 and S7 corresponding to those in FIG. 6 and FIG. 9 in detail.

### Step S801

The details of this step are the same as those of step S601 (FIG. 10).

### Step S802

A determination part 122 determines whether the ordered commodities include a delivery-by-person commodity with reference to associated “delivery-by-person” fields in a commodity information list 133. When a delivery-by-person commodity is included (YES in step S802), the process proceeds to step S803. When no delivery-by-person commodity is included (NO in step S802), that is, when only machine deliverable commodities are included, the process proceeds to step S806.

Examples of the delivery-by-person commodity include a perishable commodity, such as a fresh food, and an easily breakable or fragile commodity, such as a precision machine and a glass product. Examples of the machine deliverable commodities include a commodity requiring a large burden on a clerk, such as a very heavy commodity and a large commodity. Examples of the very heavy commodity include a metallic product.

In a case where there is a plurality of ordered commodities and the ordered commodities include at least one ordered commodity to be delivered by a person, a clerk delivers the ordered commodities to give a priority to the delivery-by-person commodity.

### Step S803

The details of this step are the same as those of step S602 (FIG. 10).

### Step S804

The details of this step are the same as those of step S7 (FIG. 6).

### Step S805

The details of this step are the same as those of step S8 (FIG. 6).

### Step S806

The determination part 122 determines a delivery machine to deliver an ordered commodity. Here, one delivery machine is determined from among a plurality of delivery machines which a store has. The one delivery machine is determined, for example, at random from among delivery machines in standby.

### Step S807

The determination part 122 determines parking location information. In step S807 in the case of “NO” in step S801, the determination part 122 determines location information about a second area as the parking location information. In step S807 in the case of “NO” in step S802, the determination part 122 determines location information about a first area as the parking location information.

### Step S808

The determination part 122 sends delivery machine information about the delivery machine to a store terminal 4.

### Step S809

The output part 123 outputs output information and the delivery machine information to a user terminal 3.

Conclusively, the sixth embodiment enables determination of a suitable delivery way depending on a kind of ordered commodity, and accordingly attains an efficient delivery of the commodity.

### Modifications

Hereinafter, modifications of the present disclosure will be described. A clerk may put a commodity ordered by a user in a delivery locker provided at a store. The delivery locker is arranged on an outer wall of a store 301 around a doorway 311 thereof. The delivery locker includes a plurality of storage boxes. In this case, in step S602 in FIG. 10, a determination part 122 may further designate a storage box located near the doorway 311. In the example in FIG. 13, when the ordered commodity is a fresh fish, the determination part 122 may designate a storage box near the left doorway 311 which is closest to a fresh fish section 321. Specifically, the determination part 122 may designate the storage box which is closest to the left doorway 311 among a plurality of storage boxes which are vacant without being occupied. The determination part 122 may further determine, as parking location information, location information about a parking location near the designated storage box.

In the example in FIG. 13, the determination part 122 may determine a division A defined in advance as a division which is within the first predetermined distance from the left doorway 311 as a parking location, or may determine a vacant space among vacant spaces in the division A as a parking location.

An output part 123 may output information about the determined storage box to a store terminal 4 and output the parking location information and the information about the storage box determined by the determination part 122 to a user terminal 3.

This disclosure is useful for an efficient delivery of a commodity in a large-scale store.

1. An information processing method for providing information about delivery of commodities at a store, the information processing method comprising:
by a computer,
acquiring entry information indicating an entry of a user into an administrative region of the store and including a user ID, and ordered commodity information indicating an ordered commodity associated with the user ID;
determining location information about a parking location for the user to park a vehicle as parking location information on the basis of parking information including location information about parking locations in a parking place in the administrative region and the ordered commodity information, the parking information and the commodity information being held in a memory; and
outputting output information including the parking location information.

2. The information processing method according to claim 1, wherein the parking place includes a first area which is within a first predetermined distance from the store, and,
in the determining, it is determined on the basis of a commodity information list held in the memory and showing each of the commodities in the store whether the ordered commodity includes a specific commodity, and location information about the first area is determined as the parking location information when the ordered commodity is determined to include the specific commodity.

3. The information processing method according to claim 2, wherein the first area is a parking area which is within the first predetermined distance from a doorway of the store.

4. The information processing method according to claim 2, wherein,
in the acquiring, vacant information indicating a vacant space which is vacant without being occupied by a vehicle in the parking place is acquired, and,
in the determining, when the specific commodity is determined to be included, it is determined on the basis of the vacant information and the location information about the first area whether the first area includes the vacant space, and the location information about the first area is determined as the parking location information when the first area is determined to include the vacant space.

5. The information processing method according to claim 4, wherein the parking location information includes location information about the vacant space in the first area.

6. The information processing method according to claim 2, wherein the store has a plurality of doorways,
in the acquiring, commodity location information indicating respective locations of the commodities in the store and doorway information indicating respective locations of the doorways is acquired,
in the determining, a location of the ordered commodity is specified on the basis of the commodity location information and the ordered commodity information, and a first doorway which is at a shortest distance from the specified location of the ordered commodity among the doorways is specified on the basis of the doorway information, and
the first area is a parking area which is within the first predetermined distance from the first doorway.

7. The information processing method according to claim 2, wherein the store has a plurality of doorways,
the ordered commodity information indicates a plurality of the ordered commodities,
in the acquiring, location information about a store terminal, commodity location information indicating respective locations of the commodities in the store, and doorway information indicating respective locations of the doorways is further acquired,
in the determining, a location of a first ordered commodity which is outside a second predetermined distance from a location of the store terminal among the ordered commodities is specified on the basis of the ordered commodity information, the commodity location information, and the location information about the store terminal, and a first doorway which is at a shortest distance from the location of the first ordered commodity is specified on the basis of the doorway information, and
the first area is a parking area which is within the first predetermined distance from the first doorway.

8. The information processing method according to claim 2, wherein the store has a plurality of doorways,
the ordered commodity information indicates a plurality of the ordered commodities,
in the acquiring, commodity location information indicating respective locations of the commodities in the store, doorway information indicating respective locations of the doorways, and weight information about each of the commodities is further acquired,
in the determining, a second ordered commodity having a weight exceeding a predetermined weight among the ordered commodities is specified on the basis of the weight information, and a third doorway which is at a shortest distance from a location of the second ordered commodity is specified on the basis of the commodity location information and the doorway information, and
the first area is a parking area which is within the first predetermined distance from the third doorway.

9. The information processing method according to claim 2, wherein the specific commodity includes at least one of a commodity having an attribute of requiring a rapid delivery to the user and a commodity having an attribute of putting a large burden on a clerk for a delivery to the user.

10. The information processing method according to claim 2, wherein the specific commodity includes at least one of a fresh food, a frozen food, a precision machine, and a large commodity.

11. The information processing method according to claim 1, wherein the output information includes display data of a display screen image showing the parking location which is in the administrative region and is indicated by the parking location information.

12. The information processing method according to claim 1, wherein the output information includes display data of a display screen image showing a location of the ordered commodity in the store.

13. The information processing method according to claim 1, wherein the output information includes display data of a display screen image showing a treatment of the store for the ordered commodity from the entry of the user into the administrative region to a delivery of the ordered commodity to the user.

14. The information processing method according to claim 1, wherein the output information includes display data of a display screen image showing a current location of a clerk delivering the ordered commodity in the store.

15. The information processing method according to claim 1, wherein the output information is output to a user terminal carried by the user and a store terminal carried by a clerk of the store.

16. The information processing method according to claim 1, wherein the memory holds a user database associating the user ID and a vehicle number with each other, and,
in the acquiring, a vehicle image is acquired by photographing the vehicle in the entry into the administrative region by the camera, the vehicle number is specified from the vehicle image, and the entry information is determined to be acquired when the user ID associated with the specified vehicle number is specified from the user database.

17. An information processing device that provides information about delivery of commodities at a store, the information processing device comprising:
an acquisition part that acquires entry information indicating an entry of a user into an administrative region of the store and including a user ID, and ordered commodity information indicating an ordered commodity associated with the user ID;
a determination part that determines location information about a parking location for the user to park a vehicle as parking location information on the basis of parking information including location information about parking locations in a parking place in the administrative region and the ordered commodity information, the parking information and the commodity information being held in a memory; and
an output part that outputs output information including the parking location information.

18. A non-transitory computer readable recording medium storing an information processing program for providing information about delivery of commodities at a store, the information processing program comprising:
causing a computer to execute:
acquiring entry information indicating an entry of a user into an administrative region of the store and including a user ID, and ordered commodity information indicating an ordered commodity associated with the user ID;
determining location information about a parking location for the user to park a vehicle as parking location information on the basis of parking information including location information about parking locations in a parking place in the administrative region and the ordered commodity information, the parking information and the commodity information being held in a memory; and
outputting output information including the parking location information.
